(19) United States
(12) Patent Application Publication
(10) Pub. No.: US 2006/0221267 A1
(43) Pub. Date: Oct. 5, 2006

(54) Projection display using dedicated color pixels

(76) Inventors: Cynthia Bell, Chandler, AZ (US); Thomas E. Willis, Mountain View, CA (US); Paul Winer, Santa Clara, CA (US); Anders Grunnet-Jepsen, San Jose, CA (US)

Correspondence Address: TROP PRUNER & HU, PC, 1616 S. VOSS ROAD, SUITE 750, HOUSTON, TX, 77057-2631, US

(21) Appl. No.: 11/092,648

(22) Filed: Mar. 29, 2005

(51) Int. Cl. G02F 1/1335

(52) U.S. Cl. 349/5

(57) ABSTRACT

A projection display system may use a microdisplay that has pixels that are dedicated to only one narrow wavelength band. A suitable optical filter for each primary display color may be formed from a small number of optical layers, taking advantage of both the rounded profile and narrow range of the emission peaks in a typical projection light source. Thus, groups of pixels may be dedicated to each wavelength band of the display. A planarization layer may be coated on dichroic filter elements that are applied to a cover glass to provide the dedicated wavelengths for each pixel. The planarization layer may smooth out any surface irregularities resulting from the deposition of the dichroic layers on the cover glass.

### BACKGROUND

This invention relates generally to projection displays.

A projection display system typically includes one or more spatial light modulators (SLMs) that modulate light for purposes of producing a projected image. The SLM may include, for example, a liquid crystal display (LCD) such as a high temperature polysilicon (HTPS) LCD panel or a liquid crystal on silicon (LCOS) microdisplay, a grating light valve or a MEMs (where “MEMs” stands for microelectro-mechanical devices) light modulator such as a digital mirror display (DMD) to modulate light that originates from a lamp of the projection display system.

In typical projection display systems, the lamp output is formatted with optics to deliver a uniform illumination level on the surface of the SLM. The SLM forms a pictorial image by modulating the illumination into spatially distinct tones ranging from dark to bright based on supplied video data. Additional optics then relay and magnify the modulated illumination pattern onto a screen for viewing.

The SLM typically includes an array of pixel cells, each of which is electrically controllable to establish the intensity of a pixel of the projected image. In some projection display systems, SLMs are transmissive and in others, they are reflective. For the purposes of simplification, the discussion will address reflective SLMs.

An SLM may be operated in an analog manner by applying analog voltages to each pixel to effect a range of projected pixel brightnesses from black to grey to white. An SLM may also be operated in a digital manner so that each pixel has only two states: a default reflective state which causes either a bright or a dark projected pixel and a non-default reflective state which causes the opposite projected pixel intensity. In the case of an LCOS SLM, the pre-alignment orientation of the liquid crystal material and any retarders in the system determine whether the default reflective state is normally bright or normally dark. For the purposes of simplification, the discussion will denote the default reflective state as normally bright, i.e., one in which the pixel cell reflects incident light into the projection lens (the light that forms the projected image) to form a corresponding bright pixel of the projected image. Thus, in its basic operation, the pixel cell may be digitally-controlled to form either a dark pixel (in its non-default reflective state) or a bright pixel (in its default reflective state). In the case of a DLP SLM, the states may represent the pixel in a co-planar position to the underlying substrate.

Although its pixels are operated digitally, the above-described digitally-driven SLM may also be used in an application to produce visually perceived pixel intensities (called “gray scale intensities”) between the dark and bright levels. For such an application, each pixel may be controlled by pulse width modulation (PWM), a control scheme that causes the human eye to perceive gray scale intensities in the projected image, although each pixel cell still only assumes one of two states at any one time. The human visual system perceives a temporal average of pixel intensity when the PWM control operates at sufficiently fast rates.

In the PWM control scheme, a pixel intensity (or tone) is established by controlling the time that the pixel cell stays in its reflective state and the time that the pixel cell remains in the non-reflective state during an interval time called a PWM cycle. This type of control is also referred to as duty cycle control in that the duty cycle (the ratio of the time that the pixel cell is in its reflective state to the total time the pixel cell is in its non-reflective and reflective states) of each PWM cycle is controlled to set the pixel intensity. A relatively bright pixel intensity is created by having the pixel cell spend a predominant proportion of time in its reflective state during the PWM cycle, while a relatively dark pixel intensity is created by having the pixel cell spend a predominant amount of time in its non-reflective state during the PWM cycle.

Projection displays with single microdisplay panels that serve all three primary colors may be desirable to meet mass market price targets for large screen, high definition, televisions. Known single-panel display systems suffer from brightness losses and/or visual artifacts that consumers may find objectionable. For example, single-panel light engines may time share the single panel for red, green, and blue images, while illumination is sequentially modulated by means of a color wheel or spinning prism. For example, with a color wheel, with green data displayed, green illumination is applied to the panel. With blue data displayed, blue illumination is applied to the panel. With red data displayed, red illumination is applied to the panel. In a scrolling prism system, all three narrow color strips of red, green, and blue illumination move down or across the panel. The data must be synchronized to display the correct data for the color of impinging illumination.

Using time sequential illumination by red, green, and blue light may be subject to limitations, depending on whether the system is modulated by a color wheel or a rotating prism. If the illumination is modulated by the color wheel, the system brightness may suffer because only one-third of the illumination wavelengths are passed by the color wheel to impinge on the SLM Further, during periods when the color spoke transitions through the illuminating beam, the panels must be held in their dark state. When this is not done, the display does not achieve full saturation in each of the primary colors. Together, these two effects significantly reduce the brightness of a colorwheel based system. In the rotating prism approach, the illumination is modulated by color prefiltering and then bands of red, green, and blue light are scrolled by the rotation of the prism. Thus, all wavelengths of the illumination source pass through the prism onto the SLM. However, some rows or columns of a scrolling panel must also be held dark where the colors transition. Thus, the overall reflecting surface is reduced. Overall, color sequential systems may be less bright than non-temporal systems.

Further, color sequential illumination may cause visual artifacts. These artifacts are known as color breakup artifacts and are the result of an object of interest moving across the screen and being imaged by the viewer's eye. If the eye and the object have relative motion, the subsequent retinal images do not overlap spatially. Instead, there will be a motion displaced blue image, then a motion displaced red image, then a motion displaced green image. The eye does not fuse the three color records in such cases and color break up is perceived. The image can still exhibit color breakup in video systems when color fields are sequentially updated as rapidly as 2000 Hertz.

### BRIEF DESCRIPTION OF THE DRAWINGS

FIG. 1 is a schematic depiction of a projection display according to one embodiment of the present invention;

FIG. 2 is a partial, enlarged, top plan view of a microdisplay useful in the projection display shown in FIG. 1 in accordance with one embodiment of the present invention;

FIG. 3 is a partial, enlarged, top plan view of another microdisplay that may be utilized in some embodiments of the projection display shown in FIG. 1;

FIG. 4 is a partial, enlarged, top plan view of still another embodiment of a microdisplay for some embodiments of the projection display shown in FIG. 1;

FIG. 5 is a greatly enlarged, cross-sectional view taken generally along the line 5-5 in FIG. 2;

FIG. 6 is an illustrative plot of relative intensity versus wavelength for a light source; and

FIG. 7 is a schematic depiction of the alignment between a cover glass and a semiconductor substrate in accordance with one embodiment of the present invention.

### DETAILED DESCRIPTION

The projection display 30 may include a lamp 32, such as a ultrahigh pressure (UHP) mercury lamp. Lamp 32 may emit broadband illumination in the visible spectrum and beyond. That illumination passes through an ultraviolet and infrared filter 34 into a homogenizing light pipe or integrating rod 36 that, in one embodiment, forms the illumination into a uniform, rectangular, beam shape, called a light box. The light pipe 36 may also incorporate illumination polarization and polarization recovery. The light pipe 36 may also include a pre-polarizer to select one polarization for the light to be provided to the microdisplay 10.

In addition, the light pipe 36 may, if sufficiently long, subject light to multiple reflections so that light reflected back from the microdisplay 10 may be recaptured, and reapplied in a different way through multiple reflections back to the microdisplay 10. In some embodiments, the microdisplay 10 includes a plurality of pixels, each of which are dedicated to a particular wavelength or color of light. Thus, at each pixel, wavelengths other than the dedicated wavelength are rejected, passed back to the light pipe 36 where the light may ultimately be recycled through the lamp 32 and provided back to the microdisplay 10. This recycling of the reflected light reduces the light energy that is lost by reflection from dedicated pixels in the microdisplay 10.

A polarization beam splitter 38 reflects incoming light in a first polarization to the microdisplay 10 and passes light reflected from the microdisplay 10 in a second polarization to the projection or relay lens 40 for display on a projection screen (not shown). Display driver electronics 42 may drive the microdisplay 10. The microdisplay 10 may use a conventional light valve, including a liquid crystal-on-silicon (LCOS) microdisplay, a grating light valve, or a microelectromechanical devices light modulator, to modulate light from the lamp 32.

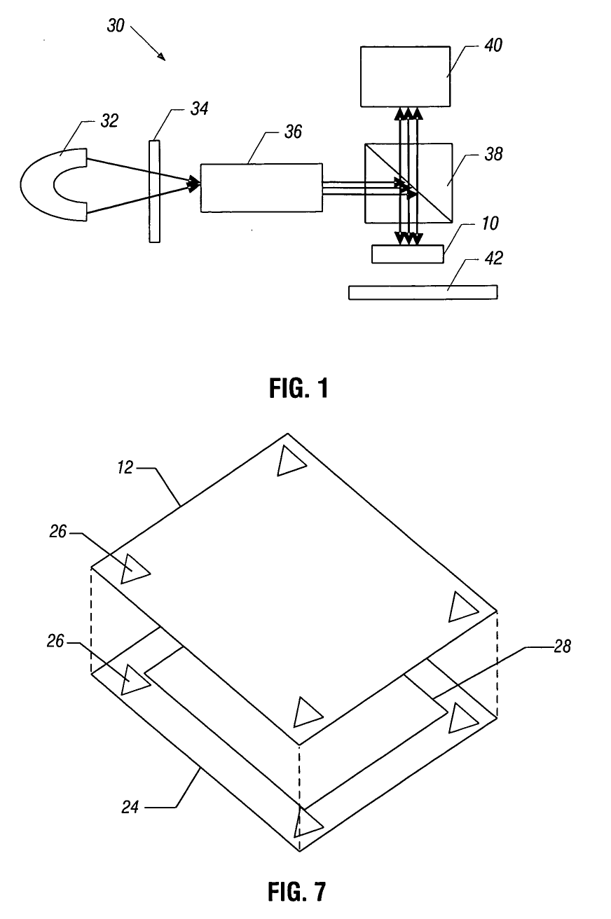

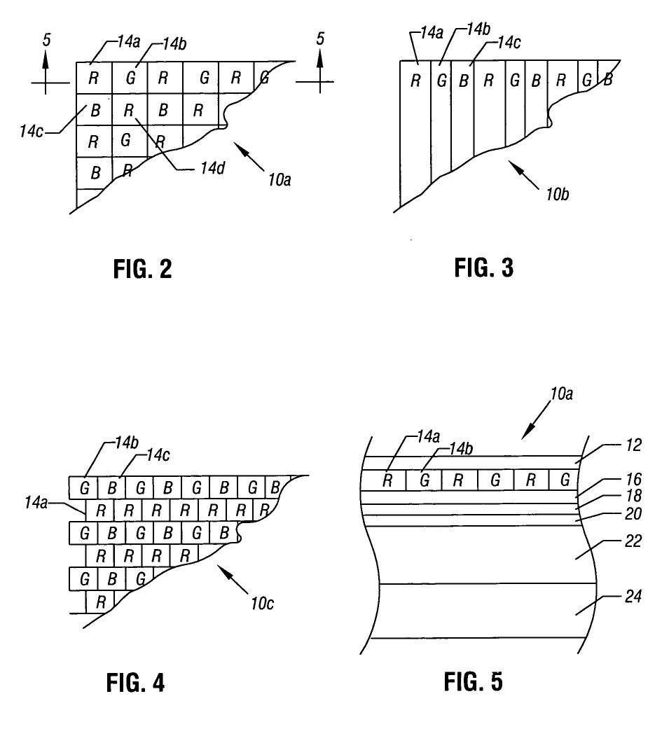

In accordance with one embodiment of the present invention, the microdisplay 10 of FIG. 1 may be implemented by microdisplay 10a of FIG. 2. The microdisplay 10a includes groups of four pixels 14a, 14b, 14c, and 14d. Each pixel of the microdisplay 10a may be dedicated to displaying a particular band of wavelengths of light. Thus, each quad of pixels 14a through 14d may contain pixels specific for red, green and blue light. For example, two pixels 14a and 14d may be dedicated to displaying red light. They may be formed by dichroic filters which pass red light wavelengths and reflect other wavelengths back for recycling. The pixel 14b may pass green light and the pixel 14c may pass blue light. Thus, each of the pixels 14a-14d may be dedicated to one of three possible wavelength bands. They are each implemented by an appropriate filter such as a dichroic filter which passes only the appropriate wavelengths. The underlying pixel reflects broadband light and only displays information associated with the color passed by the overlying dichroic filter.

In the embodiment shown in FIG. 2, a quad set of pixels may be repeated over and over and over. The reason for using two red pixels for each quad is that many light sources do not provide enough light at the red wavelengths and it assists in managing display brightness and white point to have twice as many red pixels.

Thus, referring to FIG. 5, in one embodiment, the microdisplay color filters 10a may be implemented by forming them on a cover glass 12. The dichroic elements 14a, 14b, 14c, and 14d may be formed on the glass 12 in juxtaposition to one another on a surface that ultimately will be an inside facing surface of the glass 12. A suitable optical filter for each of the three primary display colors may be formed from a small number of optical layers, taking advantage of both the rounded profile and narrow range of the emission peaks in a typical projection light source. For liquid crystal reliability, it is desirable to avoid the light source emission peaks shorter than 425 nm. Thus, an optical filter passing the emission peak at 440 nm is desirable for pixels that receive blue image data. The light source emission peak at 550 nm is desirable for pixels that receive green image data. The emission peak at 580 nm is avoided, as it diminishes the color gamut of green and red hues in the projected image. As there is no desirable emission peak in the red wavelengths, the optical filter design can pass a broader set of wavelengths and in the wavelength range between 590 nm and 660 nm.

For image capture systems, such as linear charge coupled device (CCD) scanner arrays, dichroic filters approach a square filter profile to minimize color bias in scanning operations. To achieve a square profile, many tens of layers of material may be needed to realize the dichroic filter design. However, for projection applications, a rounded profile is well suited to the emission profile of the light source. Thus, projection applications can use fewer layers to realize satisfactory dichroic filter profiles and realize a manufacturing cost advantage.

In addition to using a dichroic filter, alternate means of wavelength band selection such as diffraction gratings and holograms may be utilized.

A planarization layer 16 may then be applied over the filter elements 14a. The filter elements 14 may have thickness variations that may cause variations in the underlying liquid crystal layer thickness, resulting in a variation in the tonescale range of red, green and blue pixels. This would interfere with proper image color and tone rendering in the projected image. Thus, the planarization layer 16 may overcome this effect by providing a smooth consistent thickness across the pixels. Over the planarization layer 16 may be applied the indium tin oxide electrode 18. In many embodiments, it is desirable that the planarization layer match the refractive index of the indium tin oxide layer. A polyamide or other liquid crystal alignment layer 20 may be applied thereover to complete the top plate of the liquid crystal cell.

The structure just described sandwiches the liquid crystal material 22 between itself and a semiconductor wafer 24. In some embodiments of the present invention, the wafer may include liquid crystal-on-silicon microelectronic elements fabricated in that wafer 24. Thus, the liquid crystal material 22 may be activated to reflect the incoming phase of light or rotate the incoming phase of light of the color passed by each dichroic element 14. Light with rotated polarization phase is passed by the polarizing beam splitter 38 out to the projection lens and become bright tones on the screen. As a result, an image may be formed.

Referring to FIG. 3, in accordance with another embodiment of the present invention, the microdisplay 10b may be implemented by dedicated striped pixels 14a, 14b, and 14c. These pixels may be in the form of elongate stripes. This may have the advantage of providing a microdisplay with fewer edges. In the illustrated embodiment, the red pixels 14a may be provided in a thicker stripe than the green pixels 14b or the blue pixels 14c for the brightness and white balance reasons described previously.

In accordance with still another embodiment of the present invention, the microdisplay 10c may be provided with a row of green and blue pixels 14b, followed by a row of red pixels 14a as shown in FIG. 4. The red pixels 14a may be offset by one-half pixel width from the green and blue pixels 14b and 14c to form a triad shaped group of pixels. Thus, the pixels in the triad provide the needed wavelengths to reproduce and display a desired image. Because the red pixels are put side-by-side, they may be more easily formed from a continuous, unitary stripe of filter elements 14 which has fewer edges compared to the structure shown in FIG. 2, for example.

In some embodiments of the present invention, each of the dichroic filter elements 14 may be formed by depositing of layers of materials having desired optical index of refraction properties and the layer stack may be patterned by coating with a resist which may be used to protect desired regions while an etch process removes unwanted regions of material. Thus, conventional semiconductor fabrication techniques may be used to formulate the dichroic filters of the appropriate wavelengths at the appropriate positions.

The fabrication of suitable dichroic filters for use as the filter elements 14 is well known to those skilled in the art. U.S. Pat. Nos. 5,510,215, 5,360,698, 5,246,803, and 5,120,622 all disclose techniques suitable for a conventional semiconductor fabrication for applying suitable dichroic filters to structures such as the cover glass 12.

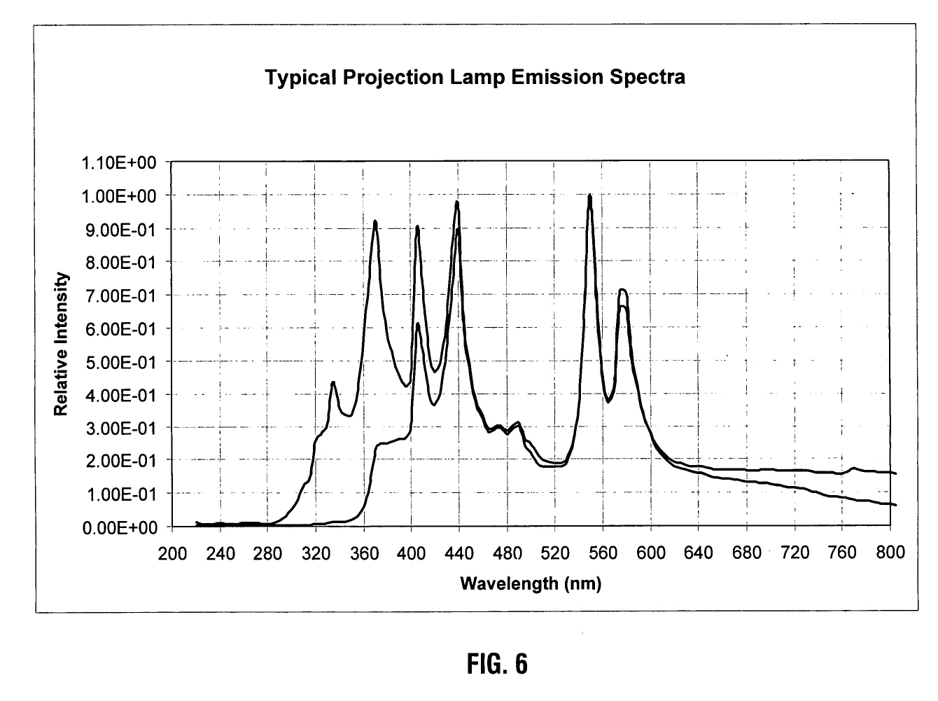

Relatively narrow band dichroic filters may be utilized as the filter elements 14, in some embodiments, because of certain characteristics of the light produced by many light sources such as UHP light sources. As shown in FIG. 6, an exemplary light source does not produce a relatively even distribution of wavelengths of the same intensity but, instead, produces a plurality of distinct intensity spikes associated with only a few distinct wavelengths. The inventors of the present invention have realized that these spikes dominate the effects of the light on the microdisplay 10. As a result, dichroic elements 14 may be designed primarily to filter and/or pass those spikes. While in traditional dichroic applications, it is desired to have a relatively square filter effect, this is unnecessary in the projection display application and to do so may require a number of layers to form the dichroic elements 14. For projection display, a suitable Gaussian profile may be achieved with fewer optical material layers by designing the elements 14 to pass the wavelengths associated with the intensity spikes produced by projection display light sources at 440 mnm (blue), 550 nm (green) and a broader Gaussian centered in the 590-620 nm region.

It is desirable for each of the dichroic elements 14a, 14b, 14c, and 14d, if utilized, to line up with the appropriate pixel electrodes that are the image creating elements in the semiconductor wafer 24. To this end, the composite of the glass 12 may be aligned with the semiconductor wafer 24 using conventional optical alignment tools as indicated in FIG. 7. Namely, the structures may be aligned using alignment indicators 26 in the periphery of the glass and on the semiconductor wafer 24, likewise, in its periphery. Alignment marks are routinely used in semiconductor manufacturing equipment to orient and align masks to wafers with placement accuracy of fractions of 65 nm today. Microdisplay pixel sizes are typically restricted to sizes of 3-12 um per side, to achieve satisfactory brightness efficiency, in proportion to the ratio of active pixel area to non-active area. Thus, conventional alignment tools are sufficiently precise for aligning a filter array to pixel electrodes. A glue layer 28, confines the liquid crystal 22 and defines the periphery of the wafer 24 and the glass 12.

In some embodiments of the present invention, a relatively cost-effective, simple structure may be achieved which does not require color wheels or color switches. Such displays may have improved brightness by recovering dark state time required with other color illumination modulation techniques to prevent loss of color gamut. The light engine costs may be reduced because of fewer moving parts and the reduction in parts in some embodiments. Since each pixel is always used for only one color, pixel values may be more highly correlated across video fields, reducing back plane switching and power consumption in some embodiments. In addition, since each pixel is a constant color, operation of the display may occur at normal video refresh frequencies such as 60 to 120 Hertz. These slower rates are more compatible with vertically aligned nomadic (VAN) mode liquid crystal material, which has switching times of 4 to 8 milliseconds and is highly desirable for liquid crystal product reliability and lifetime in some embodiments.

In addition, pixel data may be updated as a multicolor sub-set instead of by segregated color group in some embodiments. That is, a fraction of each of the R,G and B pixels may switch to updated data buffers at the same time. A benefit of this is the prevention of a visible artifact known as color breakup that can occur when pixels are updated in segregated color groups. Thus, the entire refresh of the array may be spaced out, if needed, during the video field time to better manage current drain while not inducing color break-up.—Color breakup may be reduced or eliminated in some embodiments.

Since microdisplays may be fabricated with millions of pixels, the projection lens resolution may be lower than the display resolution. This offers two improvements. First, the visibility of individual display pixels may be reduced as the color pixel groups are projected as a single image spot with merged spectra. Thus, if the dichroics are linear, then the triplets, in the case of the embodiment shown in FIG. 4, are merged and in the case of the embodiment shown in FIG. 2, groups of four pixels are imaged as one larger pixel through the projection lens. Second, the cost of the projection lens is potentially lower and the number of degrees of freedom for the lens design is increased when the resolution requirements are reduced. This enables other optical image quality factors to be improved, such as low geometrical distortion and chromatic field alignment. While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
forming a projection display using a plurality of pixels each dedicated to one wavelength band.

2. The method of claim 1 including using dichroic elements to filter all light but the dedicated wavelengths for said pixels.

3. The method of claim 2 including forming said dichroic filter by depositing said dichroic filter on a cover glass of a liquid crystal microdisplay.

4. The method of claim 3 including forming said cover glass over a liquid crystal over a semiconductor microdisplay.

5. The method of claim 1 including forming a microdisplay with groups of four pixels, including two red pixels, a blue pixel, and a green pixel.

6. The method of claim 1 including providing a microdisplay with repeating triad of red, blue, and green pixels.

7. The method of claim 6 including forming pixels that pass one color as a continuous stripe of dichroic material.

8. The method of claim 1 including forming groups of pixels in stripes.

9. The method of claim 8 including forming said stripes of different thicknesses.

10. The method of claim 1 including forming dichroic elements underneath a cover glass of a liquid crystal display, coating said dichroic elements with a planarization layer and covering said planarization layer with an indium tin oxide layer.

11. A microdisplay comprising:
groups of pixels each dedicated to a particular wavelength band.

12. The microdisplay of claim 11 including a plurality of quads of pixels, each quad including two red pixels, and a blue and a green pixel, said quad arranged generally in a square.

13. The microdisplay of claim 11 including a plurality of triads of pixels, each triad having a triangular shape and including red, blue, and green pixels.

14. The microdisplay of claim 13 wherein said red pixels form a strip of pixels.

15. The microdisplay of claim 11 including a plurality of stripes of pixels of each of three colors.

16. The microdisplay of claim 15 wherein said stripes have different widths for different colors.

17. The microdisplay of claim 11 wherein said microdisplay includes a liquid crystal material, a cover glass over said liquid crystal material, and a filter associated with said cover glass.

18. The microdisplay of claim 17 wherein said filters are dichroic filters deposited on said cover glass.

19. The microdisplay of claim 18 including a planarization layer over said dichroic filters.

20. The microdisplay of claim 11 including a dichroic pass filter for each pixel to pass particular wavelengths of light.

21. The microdisplay of claim 20 in which the dichroic pass filter is made of a limited number of optical layers giving a non-square passband profile.

22. The microdisplay of claim 11 wherein said microdisplay is a liquid crystal over silicon microdisplay.

23. A projection display comprising:
a polarization beam splitter; and
a microdisplay including pixels that only produce one wavelength.

24. The display of claim 23 wherein said microdisplay is a liquid crystal over silicon microdisplay.

25. The display of claim 23 wherein said microdisplay includes a liquid crystal material, a cover glass over said liquid crystal material, and filters associated with said cover glass.

26. The display of claim 23 wherein said filters are dichroic filters coated on said cover glass.
